(19) United States
(12) Patent Application Publication
(10) Pub. No.: US 2002/0137460 A1
(43) Pub. Date: Sep. 26, 2002

(54) Universal multi-band (5 bands and more) keyless RF remote control unit using bluetooth radio module as the base

(76) Inventors: Howard Sun, Fremont, CA (US); Did-Min Shih, Milpitas, CA (US); Hakming Pau, Milpitas, CA (US)

Correspondence Address: Howard J. Sun, 40990 Encyclopedia Circle, Fremont, CA, 94538, US

(21) Appl. No.: 09/800,725

(22) Filed: Mar. 8, 2001

(51) Int. Cl. H04B 5/00

(52) U.S. Cl. 455/41; 455/66

(57) ABSTRACT

A universal multi-band (5 bands or more) RF remote control unit using Bluetooth radio module (a low cost device operating at 2.4 GHz) as the base. It is a keyless, transportable, and low cost unit which can replace most of the conventional individual, in-compatible remote control units with a single universal unit.

### FIELD OF THE INVENTION

1). The present invention relates to a universal radio frequency remote control unit.

2). This remote control unit is designed to accomplish the functions of most of the present existing radio remote control units, hence replacing them with one single unit.

3). This remote control unit is capable of operating over 5-bands or more frequency bands.

4). This remote control unit uses Bluetooth radio module (a commonly-agreed potentially lowest cost radio link device operating at 2.4 GHz) as the base to make it low cost and readily available to most consumers and households.

5). This remote control unit is designed to be keyless and displayless, further lowering its manufacturing cost.

6). The remote control unit is piggy-backed to a personal communication device (a cellular phone, a PDA, etc.).

7). This remote control unit is designed to be transportable (among personal communication devices) making it communication device platforms independent.

8). The initial deployment of the invention is by attaching it to a cellular phone handset battery compartment.

### BACKGROUND OF THE INVENTION

Wireless remote control devices are well understood in the art. For example, remote control signals transmitted via radio frequency carriers are utilized to control such things Or devices as house doors, automobile doors, garage doors, TVs, VCRs, etc. Typically, each remote control device operates in a FCC designated license-free band: 300 MHz/433 MHz/866 MHz/902-928 MHz. With only a few exceptions, most remote control units are only capable of appropriately controlling a single remote device. Consequently, many modem homes are burdened with numerous remote control devices. Numerous problems arise due to this plurality of remote control devices, including confusion on the part of the user as to which unit controls which device, and how a particular remote control unit operates. In addition, how to manage (keep) or carry those remote control units is also a problem.

One prior art to solve the problem of numerous remote control devices has been to provide a programmable stand-alone remote control unit. The unit is equipped with keyboard and display and can be placed in a programming mode to learn the remote controlled devices. However, the size of such remote unit makes it inconvenient to carry around. Furthermore, the programming task itself constitutes a rather tedious procedure, hindering an ordinary user from using it. In addition, the cost of such remote unit is also more expensive than conventional remote control units.

Another prior art provides a remote control function built-into a personal communication device (a cellular phone in particular). Nowadays, the technology changes so rapidly that new PCDs personal communication devices) will replace old PCDs in a fast pace. But remote controlled devices (e.g., the remote unit attached to a garage door) usually stay for a much longer time. Hence, every time a new PCD replaces an old PCD, a new remote control function has either to be available with the new PCD, or to be added thereto. This results in additional cost and inconvenience.

### SUMMARY OF THE PRESENT INVENTION

Accordingly, an object of the present invention is to solve the shortcomings of the previous mentioned problems related to multiple, in-compatible remote control units and the shortcomings of the prior arts. The present invention has the following features:

1). A universal radio frequency remote control unit. It covers different operating functions and different operating frequencies as described in 2) and 3) herein below.

2). This remote control unit is designed to accomplish the functions of most of the present existing radio remote control units. The invention allows control of different types of keyless entry system, garage door opener, car door opener, and home security system as well as other home appliances manufactured by different manufacturers, hence replacing them with one single unit. This simplifies the remote control device storage and handling, and also reduces the maintaining cost.

3). This remote control unit is designed to be operating over 5-bands: 300 MHz/433 MHz/866 MHz/902-928 MHz/2400˜2482 MHz/, or more frequency bands. These frequency bands are normally in the government authorized license-free radio frequency bands. To our best knowledge, this is the first remote control unit to operate over 5-bands or more.

4). This remote control unit uses Bluetooth radio module (a commonly-agreed potentially lowest cost radio link device operating at 2.4 GHz) as the base to make it low cost and readily available to most consumers and households. The Bluetooth radio is a widely adopted international standard which endeavors to accomplish low cost economical radio frequency data link solution. Adapting this technology to remote control unit and expanding its function and frequency (as describe below) makes a universal low cost remote control unit realizable. The invention is created by adding additional circuits such as frequency divider, and RF amplifier control circuit to the transmitter section of the Bluetooth radio base but without affecting Bluetooth performance. The additional size and cost is a fraction of the already low cost and small-size Bluetooth radio base (which the assignee is working on, and will also be available from many other vendors). The result of these additional circuits is that the invention can operates in 5 different frequency bands or more now (in addition to the Bluetooth 2.4 GHz band) while still compatible in size and cost.

5). This remote control unit is designed to be keyless and displayless, further lowering its size and manufacturing cost. The idea is to use the personal communication device's (as described in 6) keyboard and display, instead of duplicating them.

6). This remote control unit is piggy-backed to a personal communication device (a cellular phone, a PDA (personal data assistant), etc.) Because every PDA (personal data assistant) has a keyboard (or a stylus pen) and a display, this remote control unit doesn't have to possess these. Nowadays, more and more people carry a PDA( a cellular phone, e.g.,) with them wherever they go. The extremely small size remote control unit (with size less than half of a business card) can be easily attached to the inside of the PDA and carried with it.

7). This remote control unit is designed to be transportable (among personal communication devices) making it communication device platforms independent. It doesn't have to become obsolete with a particular PDA. This also saves the cost of replacing the PDA or replacing the remote control unit.

8). The initial deployment of the invention is by attaching it to a cellular phone handset, such as at the cellular phone battery compartment. It can be attached to other PDAs and note-book PCs as well. Cellular phone is a very popular PCD (personal communication device). For a variety of reasons, including convenience and necessity, the users of such device often maintain these handsets in relatively close proximity to themselves to facilitate their elected use by the user, or to allow the user to respond to a message being directed to the user. By attaching a universal remote control unit to it allows the simplification of people daily life in keeping and managing those multiple remote control (garage door opening, car door, home door, home security, etc.) requirements.

### BRIEF DESCRIPTION OF THE DRAWINGS

FIG. 1 is a block diagram depicting a preferred embodiment of the invention;

FIG. 2 is a block diagram depicting the transmitters BT Tx1 and Tx2 shown in FIG. 1;

FIG. 3 is a perspective view of an illustrative diagrammatic representation of the interconnection between the present invention and personal communication devices;

FIG. 4 is a block diagram depicting a PCD and the present invention;

FIG. 5 depicts a flow chart of a remote data entry mode in accordance with the present invention; and

FIG. 6 depicts a flow chart of a remote control mode in accordance with the present invention

### DETAILED DESCRIPTION OF THE PRESENT INVENTION

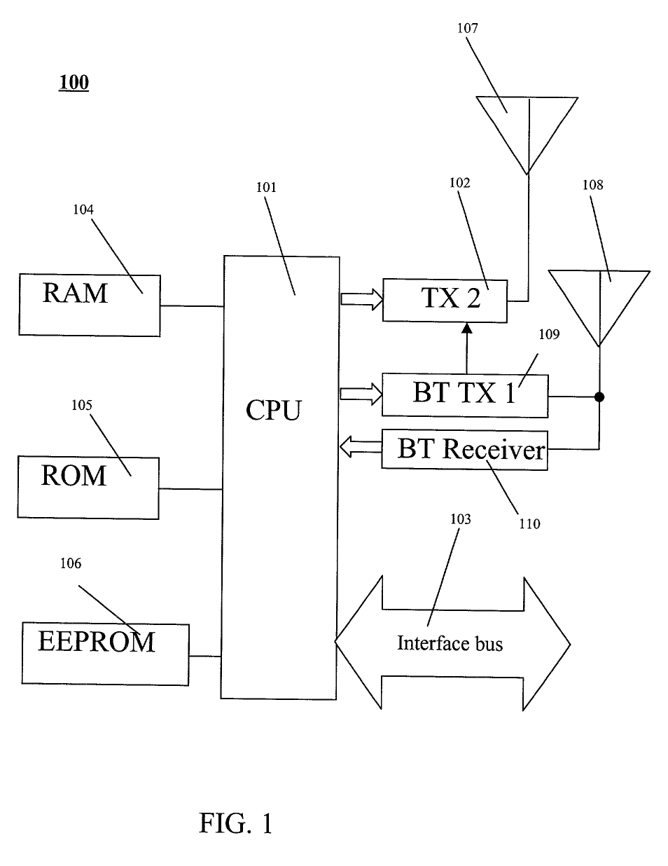

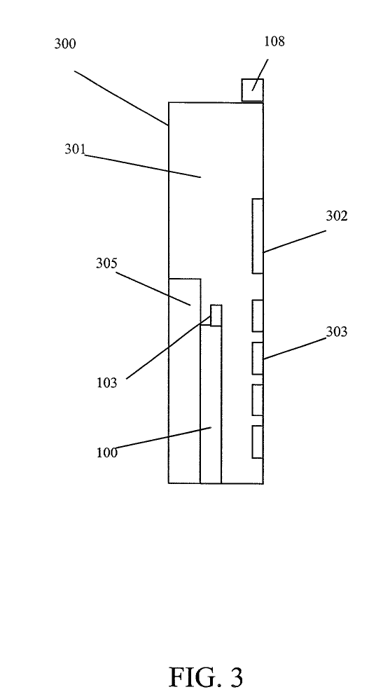

An explanation of the present invention will now be provided with reference to FIG. 1. The present invention (100) includes two transmitter sections (102, 109), a BT receiver section (110), a baseband controller CPU section (101), two antennas (107,108) and an interface bus (103) between a PCD (personal communication device) and the present invention. The interface bus (103) connects the PCD and the invention together. The baseband controller CPU section (101) couples to a plurality of memory devices, including a RAM (104), a ROM (105) and an EEPROM (106). The remote control data are keyed in to PCD (300) through a keyboard (303) (shown in FIG. 3), then pass through the interface bus (103) and store in the EEPROM (106).

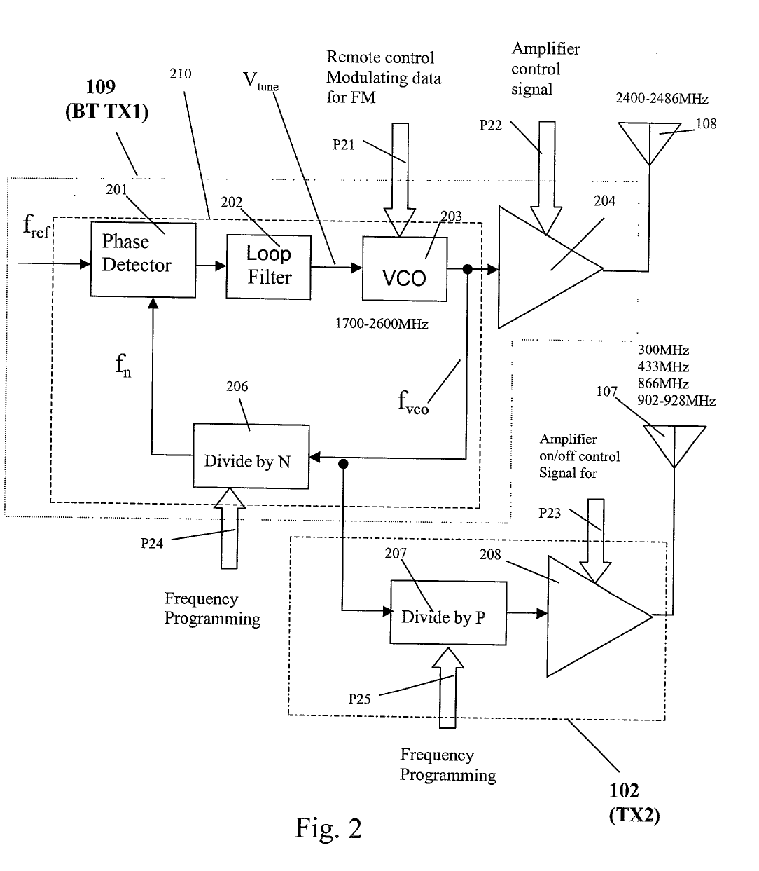

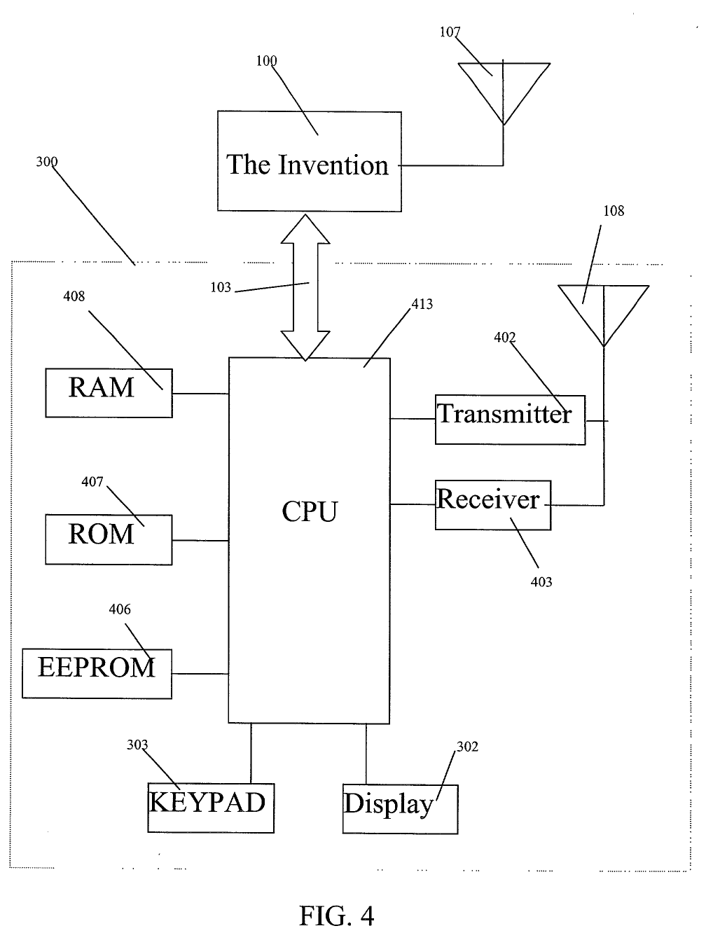

A more detail explanation of the transmitter BT Tx1 (109) and Tx2 (102) will now be provided with reference to FIG. 2. The part labeled as BT TX1 (enclosed in a dashed box) is a basic Bluetooth radio module. The part labeled, as TX2 (enclosed in another dash box) is the addition created from this invention. The phase detector (201) generates signals indicative of the phase relationship between the reference frequency fref and the scaled, synthesized frequency fn. A loop filter (202) is a low pass filter; it can be a passive filter or an active filter. The loop filter (202) smoothes the ouput signal of the phase detector (201). A VCO (203) is a voltage-controlled oscillator; its output signals frequency fvco covers 1700 to 2600 MHz at least and can be tuned by the output signal Vtune of the loop filter (202). The transmitter BT TX1 (109) and TX2 (102) includes a pll (phase-locked loop) (210), a frequency divider (207), rf amplifiers (204, 208), antennas (107, 108). With proper programming to frequency dividers (206, 207), VCO modulation (203), and RF amplifier (204, 208) on/off control, both transmitters BT Tx1 (109) and TX2 (102) will be able to operate in 5 different frequency bands or more, such as 300 MHz/433 MHz/866 MHz/902-928 MHz/2400-2486 MHz with OOK (on-off keying) and FM modulation. The antenna (107) is used to transmit signal 300 MHz to 1000 MHz; the antenna (108) is used to transmit signal around 2400 MHz. The present invention (100) configured in accordance with a PCD (300) can be seen generally as depicted in FIG. 3. It includes an appropriate housing (301), a display (302), a keypad (303), an interface bus (103), a battery (305), an antenna (108), and the present invention (100). The antenna (107) is hidden inside the present invention (100). A more detail explanation of the interconnection between the present invention (100) and the PCD (300) will now be provided with reference to FIG. 4. The present invention (100) is connected to the PCD (300) through an interface bus (103). The interface bus (103) provides all necessary signal paths required communicating between the present invention (100) and the PCD (300). The PCD (300) includes a transmitter sections (402), a receiver section (403), a controller CPU section (413), one antennas (108) and an interface bus (103) between a PCD and the present invention. The controller CPU unit (413) couples to a plurality of memory devices, including a RAM (408), a ROM (407) and an EEPROM (406).

There are two operation modes between the invention (100) and the PCD (300); one is the remote control data entry mode used for initial set up, the other one is remote control mode used for routine remote control operation.

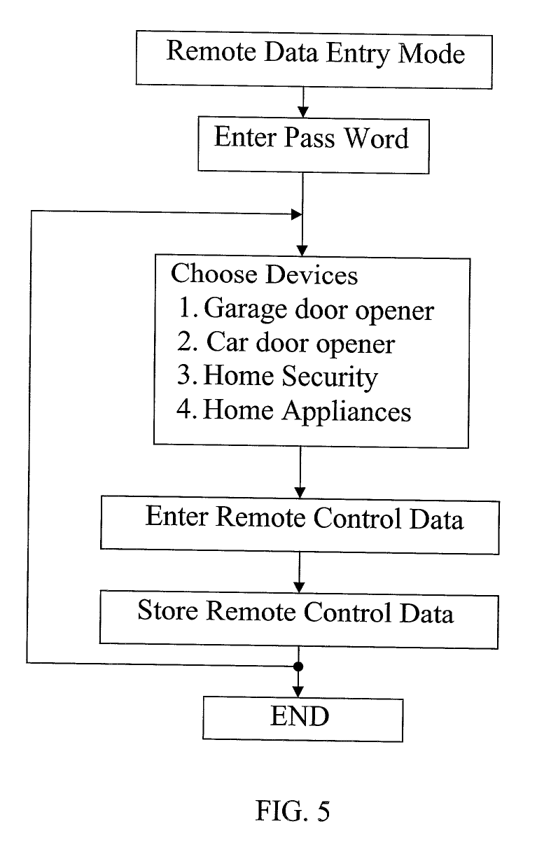

Referring now to FIG. 5 for the use of the invention (100) in a remote control data entry mode. User selects the remote control data entry mode from the PCD's display (303), then select frequency band, and then enter the proper control data (this data is normally readily available from the remote controlled devices), this control data will be sent from the PCD to the invention (100) and store in the remote control unit's EEPROM (106) via the interface bus(103) after an appropriate handshake procedure. This process is required only once (i.e. once it is entered, the remote control unit can be used with different PCDs without re-entering the control data).

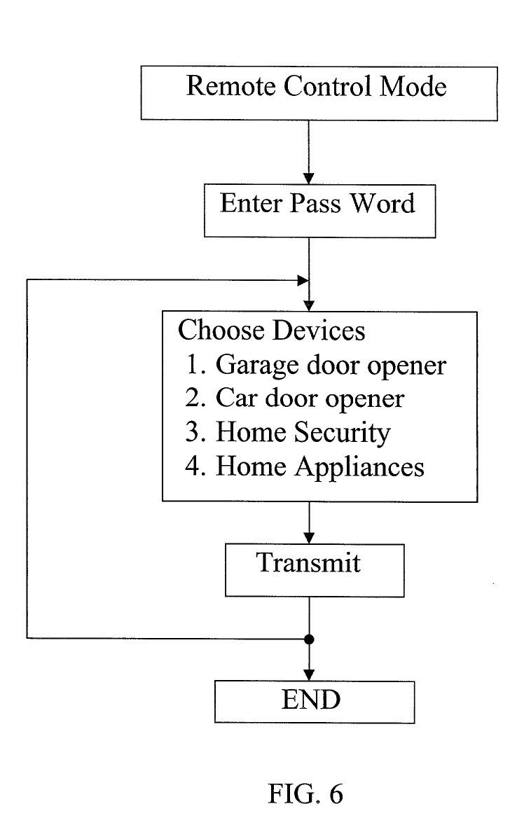

Referring now to FIG.6 for the use of the present invention (100) in a remote control mode. To begin, the user selects remote control mode from the PCD's display (303), then select a particular device to be controlled. The signal will be transmitted through antenna (107) automatically.

1. A universal multi-band keyless, transportable RF remote control unit using bluetooth radio module as the base comprising mainly CPU, at least one transmitter section, at least one receiver section, at least one interface bus, at least one antenna, and at least one RAM, one ROM, and one EEPROM, wherein the remote control unit is connected to a personal communication device through the interface bus.

2. The universal multi-band keyless, transportable RF remote control unit using bluetooth radio module as the base as claimed in claim 1, wherein there are two transmitter sections, one of them including a phase detector, a low pass filter, a first frequency divider, a first rf amplifier, and a vco (voltage-controlled oscillator); and another of them including a second frequency divider and a second rf amplifier.
